(19) United States
(12) Patent Application Publication
(10) Pub. No.: US 2001/0009593 A1
(43) Pub. Date: Jul. 26, 2001

(54) Thrust ball bearing

(75) Inventors: Rainer Pflug, Heilsbronn (DE); Wolfgang Miereisz, Herzogenaurach (DE); Thomas Motz, Herzogenaurach (DE)

Correspondence Address: Henry M. Feiereisen, Henry M. Feiereisen, LLC, Suite 3220, 350 Fifth Avenue, New York, NY, 10118, US

(73) Assignee: INA WALZLAGER SCHAEFFLER oHG, Herzogenaurach (DE)

(21) Appl. No.: 09/754,618

(22) Filed: Jan. 4, 2001

Related U.S. Application Data
(60) Provisional application No. 60/182,722, filed on Feb. 15, 2000.

(30) Foreign Application Priority Data
Jan. 21, 2000 (DE) 100 02 557.9

(51) Int. Cl. F16C 19/10

(52) U.S. Cl. 384/609

(57) ABSTRACT

A thrust ball bearing includes first and second circular ring shaped bearing disks arranged in spaced-apart disposition and moving eccentrically to one another so that bearing balls, arranged therebetween, roll on pertaining circular tracks. Both circular ring shaped bearing disks are made from a through-hardenable ferrous material to thereby permit realization of a particularly high fatigue strength.

### CROSS-REFERENCES TO RELATED APPLICATIONS

This application claims the priority of German Patent Application Serial No. 100 02 557.9, filed Jan. 21, 2000, the subject matter of which is incorporated herein by reference.

This application claims the benefit of prior filed provisional application, Appl. Ser. No. 60/182,722, filed Feb. 15, 2000, pursuant to 35 U.S.C. 119(e).

### BACKGROUND OF THE INVENTION

The invention relates, in general, to a thrust ball bearing, and more particularly to a thrust ball bearing of a type including first and a second circular ring shaped bearing disks arranged in spaced-apart disposition and moving eccentrically to one another so that bearing balls, arranged therebetween, roll on pertaining circular tracks.

Such a bearing is known from U.S. Pat. No. 5,921,684. The circular ring shaped bearing disks used there in a scroll compressor are carburized. Such bearing disks exhibit poor wear behavior, in particular when subjected to high loads, i.e. the carburization zone cracks in the transitional region to the soft core when exposed to unavoidable overload spikes. It is a further drawback that carburized bearing disks, as a consequence of lacking carbide formation, are subject to high abrasive wear, in particular when lubrication is deficient. Disadvantageous is also, that carburization is time-consuming as a result of increased diffusion times and therefore expensive. In order to minimize these drawbacks, it was proposed heretofore to provide carburized bearing disks with a safety value of 7. This means that at any depth of the raceway surface, the value is seven times the dynamic shearing stress generated in that depth underneath the raceway surface, when the rolling elements roll off, and does not fall below the hardness at that depth. In other words, the hardness in this depth must be greater by the factor 7 than the shearing stress in this depth, or the maximum admissible stress with respect to shearing stress may only be at a level of 1/7 of the hardness in this depth of the component. This safety value can, however, no longer be maintained at greater loads, so that cracks in the material as a result of flaking are experienced.

### SUMMARY OF THE INVENTION

It is thus an object of the invention, to provide an improved thrust ball bearing, obviating the afore-stated drawbacks.

In particular, it is an object of the present invention to provide an improved thrust ball bearing having circular ring shaped bearing disks of high value of fatigue strength.

These objects, and others which will become apparent hereinafter, are attained in accordance with the present invention by providing first and second circular ring shaped bearing disks arranged in spaced-apart disposition and moving eccentrically to one another, and bearing balls arranged between the first and second bearing disks for rolling along circular tracks defined by the first and second bearing disks, with the first and second bearing disks made from a through-hardenable ferrous material.

In the following description, the term “through-hardening” will denote the realization of an even martensitic structure across the entire cross section of the component during the hardening process. The continuous martensitic structure eliminates the need for the above-described safety value in correspondence with the factor 7. There is only the requirement that the hardness exceeds the effective stress resultant from the load, i.e. it is possible to fall significantly below the current factor 7. As a consequence, the through-hardened circular ring shaped bearing disks according to the invention can be subjected to a significantly higher load at otherwise same hardness.

In accordance with a further feature of the present invention, the bearing disks may be made from a unalloyed, low alloy or high alloy ferrous material, whereby “steel” is designated unalloyed when containing less than 0.5% of Si, 0.8% of Mn, 0.1% of Al or Ti, 0.25% of Cu. Low alloy steels contains less than 5% of alloying elements, whereas steels with more than 5% of alloying components are highly alloyed.

In accordance with another feature of the present invention, the bearing disks may be made from a steel of the type C 45, C 55, Ck 67, C 75, 100 Cr 6 or 85 Mn 3. All listed steels are capable to realize a complete transformation into a martensitic structure as a result of quenching during the hardening procedure after austenitization, with the critical quenching speed being relatively low so that the desired hardness is adjusted also in the core of the workpiece.

The attained hardness of the martensite increases with the carbon content. However, at carbon contents of above 0.8%, the transformation into martensite is no longer completely accomplished when quenching up to room temperature. Steel of the type C 45 with 0.42 to 0.50% of C, 0.15 to 0.35% of Si, 0.50 to 0.80% of Mn, ≦0.045% of P and ≦0.045% of S realizes hereby hardness values of ≧600 HV. Steel C 55 with 0.53 to 0.61% of C, 0.15 to 0.35% of Si, 0.60 to 0.90% of Mn, ≦0.035% of P, ≦0.035% of S realizes hereby hardness values of ≧635 HV. Steel of the type Ck 67 with a carbon content in the range between 0.68 and 0.74%, 0.15 to 0.35% of Si, 0.60 to 0.90% of Mn, ≦0.035% of P, ≦0.035% of S realizes hereby hardness values of ≧670 HV. The same is true with respect to hardness for spring steel C 75 which contains 0.70 to 0.80% of C, 0.15 to 0.35% of Si, 0.60 to 0.80% of Mn, ≦0.045% of P, ≦0.045% of S. The alloying elements chromium and manganese in the steel 100 Cr 6 and 86 Mn 3 with about 1.35% to 1.55% and 0.7 to 0.85%, respectively, provide for a reduction of the critical quenching speed and thus for a significant increase of the hardenability. The stated steels have a hardness of ≧700 HV. Moreover, the alloying elements chromium and manganese contribute advantageously to the carbide formation so that such steels are particularly wear-resistant, i.e. resistant against abrasion.

Suitably, the bearing disks can be made through a non-cutting shaping process, with the shaping speed being ≦2 m/min. The low shaping speed and the inclusion of compressive stress ensures that the components can be made at great accuracy in shape and dimension, despite the presence of the alloying elements chromium and manganese which complicate the cold-shaping procedure. Moreover, the non-cutting manufacturing process ensures a positive fiber pattern in the material, which is an additional precondition for realizing good fatigue strength.

According to another feature of the present invention, the first bearing disk can be connected with a revolving scroll member of a compressor of the type “scroll”, with the scroll member mounted on a crank pin of a shaft, with the second bearing disk received in a housing, so that the compressor space with variable volume for transport of a medium is formed during interaction of a revolving and a stationary second scroll member which is secured in the housing, and a generated thrust is absorbed by the revolving scroll member via the bearing balls.

### BRIEF DESCRIPTION OF THE DRAWING

The above and other objects, features and advantages of the present invention will be more readily apparent upon reading the following description of a preferred exemplified embodiment of the invention with reference to the accompanying drawing, in which:

FIG. 1 shows a partial longitudinal section of a scroll compressor in the area of the scroll members, having incorporated therein a thrust ball bearing according to the present invention;

FIG. 2 is a plan view of a circular ring shaped bearing disk of the thrust ball bearing; and

FIG. 3 is a graphical illustration of stress conditions in dependence from the distance from edge.

### DETAILED DESCRIPTION OF THE DRAWINGS

Throughout all the Figures, same or corresponding elements are generally indicated by same reference numerals.

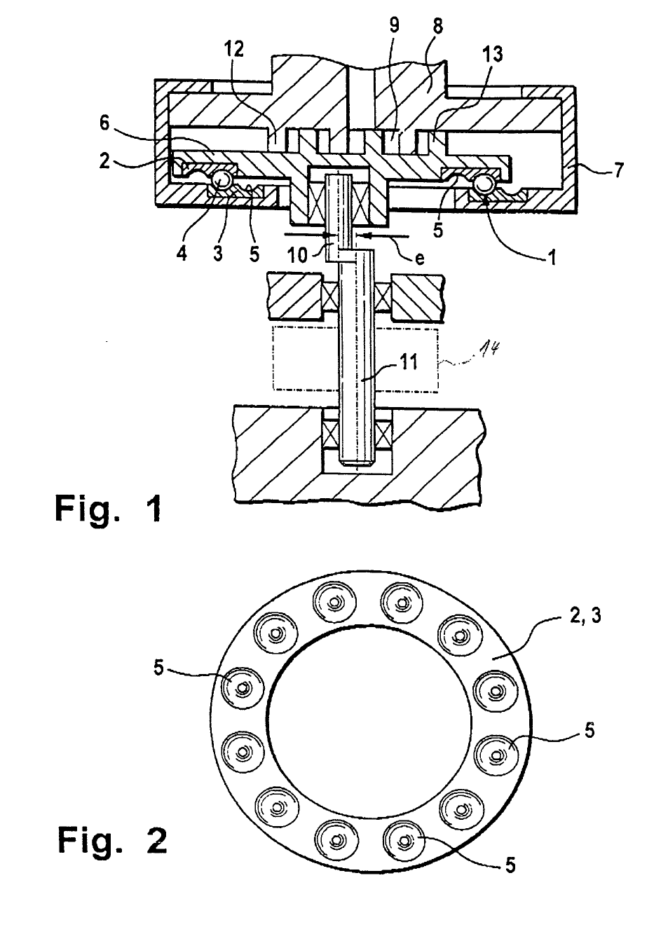

Turning now to the drawing, and in particular to FIG. 1, there is shown a partial longitudinal section of a scroll compressor which has a housing 7, a stationary scroll member 8 securely fixed to an upper part of the housing 7 and including projecting spiral elements 12, and a movable scroll member 6 having a spiral elements 13 for engagement in the spiral elements 12 of the stationary scroll member 8, thereby forming a compression space 9 which decreases or expands in response to a relative movement between both scroll members 6 and 8 for conveying a gaseous or liquid medium. The axis of the movable scroll member 6 and the axis of a driving motor 14 are out of alignment so that rotation of a shaft 11 of the driving motor 14 results in an eccentric rotation of the scroll member 6 at an eccentricity e in the stationary scroll member 8, whereby the scroll member 6 is connected in its center with a crank pin 10 of the shaft 11.

The scroll member 6 is supported in the housing 7 by a thrust ball bearing, generally designated by reference numeral 1. the thrust ball bearing 1 includes a first circular ring shaped bearing disk 2 received in the scroll member 6, a second circular ring shaped bearing disk 3 received in the housing 7, and a plurality of bearing balls 4 disposed between the bearing disks 2, 3 and circulating on separate circular tracks 5, as shown in particular in FIG. 2, which illustrates by way of a plan view one of the bearings disk 2, 3 with the recessed circular tracks 5.

The circular ring shaped bearing disks 2, 3 shown in FIG. 2 are made from a blank, which has been punched out from a metal sheet and subsequently shaped through a non-cutting shaping process on a suitable shaping apparatus, for example, a hydraulic press or a knuckle-joint press with a shaping speed of ≦2 m/min. An example of a material for the blank includes steel of type Ck 75 which contains 0.70 to 0.80% of C, 0.15 to 0.35% of Si and 0.50 to 0.80% of Mn, whereby the added k in CK 75 indicates a particularly low content of phosphorus of ≦0.035% and sulfur of ≦0.015%. After a hardening and tempering process, the thus through-hardened material has a hardness of 700 HV. The disks 2, 3 made in this manner can be subjected to a load at a safety of 1, i.e. the hardness of 700 HV permits a maximum admissible load corresponding to also 700 HV with respect to the effective stress.

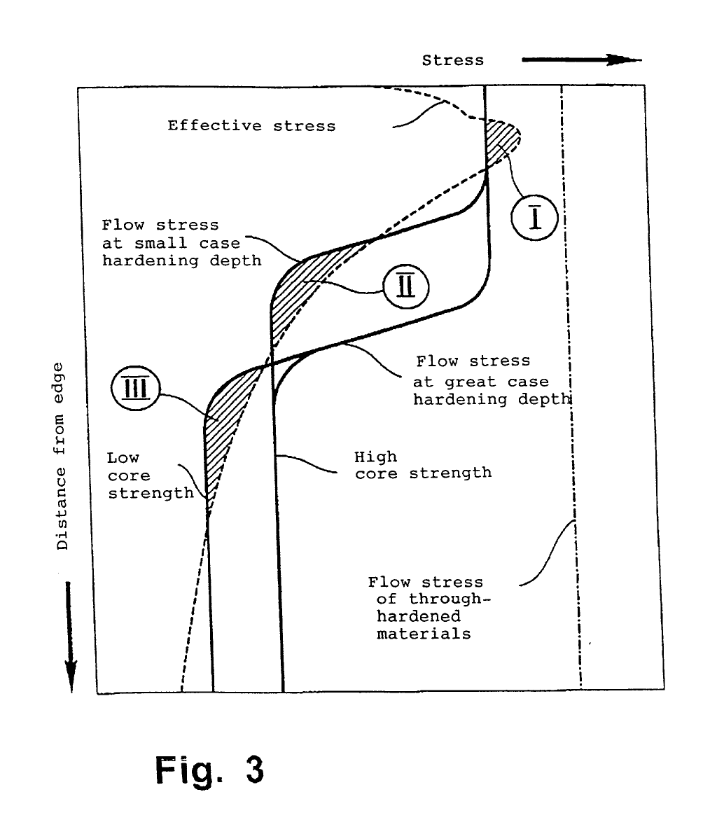

As shown in the graphical illustration in FIG. 3, the flow limit of a material is exceeded in the zone I during surface layer hardening in the area of the stress maximum of the effective stress, i.e. an undesired deformation is encountered at sufficiently high Hertzian stress. In the zone II, the material deforms plastically as the hardening depth is selected too small. In the zone III, plastic deformations are experienced when the hardness or the flow stress of the core material is too low. The dashdot line, drawn on the right side and extending from top to bottom depicts the flow stress of a through-hardened material. As can be seen, one is always on the safe side because the strength and flow limit of the through-hardened material as based on the hardness lies at all locations beyond the course of the effective stress. This means in case of the present invention that there is no need for the hardness at a certain depth to exceed the shearing stress by the factor 7, but this safety value is reduced by the invention to 1.

While the invention has been illustrated and described as embodied in a thrust ball bearing, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A thrust ball bearing, comprising first and second circular ring shaped bearing disks arranged in spaced-apart disposition and moving eccentrically to one another; and bearing balls arranged between the first and second bearing disks for rolling along circular tracks defined by the first and second bearing disks, said first and second bearing disks made from a through-hardenable ferrous material.

2. The thrust ball bearing of claim 1, wherein the bearing disks are made of an unalloyed, low-alloy or high-alloy ferrous material.

3. The thrust ball bearing of claim 1, wherein the bearing disks are made of a steel of the type selected from the group consisting of C 45, C 55, Ck 67, C75, 100 Cr 6 and 85 Mn 3.

4. The thrust ball bearing of claim 1, wherein the bearing disks are made by a non-cutting shaping process.

5. The thrust ball bearing of claim 4, wherein the shaping process is carried out at a shaping speed of ≦2 m/min.

6. The thrust ball bearing of claim 1 for use in a scroll compressor having a housing accommodating a revolving scroll member mounted on a crank pin of a shaft, a stationary scroll member secured in the housing, said first bearing disk connected with the revolving scroll member and said second bearing disk securely fixed to the housing, whereby a compressor space with variable volume for transport of a medium is formed during interaction of the revolving scroll member and the stationary second scroll member, and a generated thrust is absorbed by the revolving scroll member via the bearing balls.

7. A scroll compressor, comprising:
a housing;
a stationary scroll member secured in the housing;
a revolving scroll member accommodated in the housing and so driven as to revolve at an eccentricity relative to the stationary scroll member, thereby compressing a medium in a compression space defined between the scroll members; and
a thrust ball bearing having a first bearing disk connected with the revolving scroll member, a second bearing disk securely fixed to the housing, and bearing balls arranged between the first and second bearing disks for rolling along circular tracks defined by the first and second bearing disks, said first and second bearing disks made from a through-hardenable ferrous material.

8. The scroll compressor of claim 7, wherein the bearing disks are made of an unalloyed, low-alloy or high-alloy ferrous material.

9. The scroll compressor of claim 7, wherein the bearing disks are made of a steel of the type selected from the group consisting of C 45, C 55, Ck 67, C75, 100 Cr 6 and 85 Mn 3.

10. The scroll compressor of claim 7, wherein the bearing disks are made by a non-cutting shaping process.

11. The scroll compressor of claim 10, wherein the shaping process is carried out at a shaping speed of ≦2 m/min.
